(19) United States
(12) Patent Application Publication
(10) Pub. No.: US 2019/0337735 A1
(43) Pub. Date: Nov. 7, 2019

(54) METHOD FOR GRANULAR RESIN MATERIAL DELIVERY USING FILL TIME MONITORING AND ALARM FOR FILTER CHECK

(71) Applicant: Novated, Inc., Baltimore, MD (US)

(72) Inventors: Conrad Bessemer, Millersville, MD (US); James Zinski, Ellicot City, MD (US)

(73) Assignee: Novatec, Inc., Baltimore, MD (US)

(21) Appl. No.: 15/970,038

(22) Filed: May 3, 2018

(51) Int. Cl. B65G 53/66; B65G 53/24; G01F 23/00

(52) U.S. Cl. CPC B65G 53/66; G01F 23/0015; G01F 23/0007; B65G 53/24

(57) ABSTRACT

Apparatus for pneumatically supplying granular material from a supply to at least one receiver for temporary storage of the granular material prior to transfer to a process machine including a timer for measuring time required for loading the receiver and a microprocessor for comparing times measured by the timer and triggering an alarm when consecutively compared times increase by a preselected amount and a method and apparatus for determining when a filter of a granular material receiver providing granular material to an associated process machine, is at reduced filtering efficiency.

### STATEMENT REGARDING FEDERALLY SPONSORED RESEARCH OR DEVELOPMENT

Not applicable—this invention was conceived and developed entirely using private source funding; this patent application is being filed and paid for entirely by private source funding.

### THE TECHNOLOGY

The plastics industry is very diversified; there are thousands of different products, hundreds of materials, and dozens of processes, and all are very different from one another. The only thing all these differences share in common is that the source material is some type of plastic.

Equipment sold to this industry is, therefore, very diversified in design. Plastics factories have multiple process machines, sometimes several hundred in one location. Virtually all plastics fabricating operations require that each process machine, namely a molding press or an extruder, be supplied automatically with the required raw resin material on a continuous basis. This resin may be supplied in large boxes, called Gaylords, in fiber drums, in 50 pound bags, or more typically may be delivered by bulk truck or rail car, with the resin material then being transferred in bulk into storage silos. In all cases the resin material must be further distributed throughout the plant to each and every process machine. For that reason a great deal of design and capital expense is devoted to the automatic distribution of the raw resin material throughout the plant.

These resin distribution systems, more commonly referred to as “Loading Systems”, must deal with many variables. One set of variables includes the type, shape, size and consistency of the granular material.

Resin pellets, nominally about ⅛ inch in size, come in various shapes, with round, square, and cylindrical being the most common.

Flowing resin powder is also an option, and very fine but free flowing resin pellets and other granular materials may be conveyed as well,

The design variables to be considered for each customer include:
1. Type of resin being conveyed.
2. Size and consistency of the resin pellets.
3. Distances the resin pellets are to be conveyed.
4. Variability of these distances from shortest to longest.
5. Acceptable range for velocity of resin material travel through the lines.
6. Throughput rate of resin required for each machine.
7. Total throughput rate of resin for the entire plant.
8. Excess capacity performance margin so a molding or extrusion process is not interrupted by short term loading issues.
9. Loss of resin material from or at the supply so that only air is being pulled, thereby reducing system vacuum levels and reducing overall design throughput.
10. Loading sequence, or priority, when multiple receiver stations call for material.
11. Detecting problems and alarm conditions.
12. Proper air to material ratio for resin conveying.
13. Detecting plugged lines due to poor resin flow or over feeding of resin material.
14. Dust condition and filter requirements.
15. Reliability.
16. Serviceability.
17. Ease of use.
18. Cost
19. Vacuum pump type, namely positive displacement, regenerative, and others.
20. Vacuum pump horsepower and rated CFM capacity as well as vacuum levels.

In all of these areas, system designers look to find improved methods and solutions whenever possible.

One of the most important considerations is to hold a correct velocity for the conveyed resin material. The type of resin material dictates the target conveying speed. To maximize the resin material transfer rate, a high conveying speed is preferred, and air speed in any case must be sufficient to keep the resin pellets suspended and moving in the air stream. But velocity must be limited so as not to damage the pellets. Hard brittle pellets can fracture and break when conveyed, resulting in excessive dust.

Softer pellets can skid along the conduit walls, causing “angel hair” as a result of the plastic resin melting at the point of high speed contact with the conduit wall; this leaves a thin film on the wall. Strings of very thin “angel hair” accumulate, effectively reducing diameter of the conduit and causing problems in the system.

Air speed and resin conveying velocity are directly related to pump capacity (rated CFM) and horsepower, as well as conveying line diameter. There is always a correct velocity “range” for each type of resin material. It is a design challenge to assure that resin material is conveyed within the correct velocity range.

Conveying distances affect system design. Conveying over short distances requires a less powerful vacuum source then over longer distances. Systems are generally sized to produce the best compromise for material velocity between the shortest and longest conveying distance.

Required conveying rate usually dictates line size (tube diameter), and this in turn dictates the CFM required to maintain correct velocity in a given diameter conduit. This means different tube sizes in the same system can be a problem if one vacuum pump is to draw air and resin through several different diameter conveying lines. Pumps have known CFM ratings. Pulling air through a small tube will result in higher velocity flow than pulling the same CFM through a larger tube.

Excessive velocity can damage pellets.

The type of vacuum pump to be selected is important. Regenerative blowers deliver wide ranging CFM depending on vacuum level. Positive displacement type pumps deliver high vacuum levels, and have a flatter CFM curve over their vacuum range. Regenerative blowers are quieter and generally cost less. Positive displacement blowers may require sound enclosures and tend to cost more, but are generally more reliable and more forgiving as respecting dust in the air.

The simplest systems use a fixed speed motor to drive the vacuum pump, and a single size conveying line to serve all receivers regardless of distance, rate requirement, or material.

The invention technology offers controls and devices that can maximize performance for the variety of conditions that actually exist in a plant.

VFD (Variable Frequency Drive) motors allow vacuum pumps to operate at different speeds, and therefore at different CFM rates, with the vacuum pump pulling different vacuum levels depending on preset information about each receiver being served, and/or making adjustments based on real time feedback of vacuum sensors located at various places in the system.

The addition of a SCFM (Standard Cubic Feet per Minute) limiter in the air flow line allows oversized vacuum pumps to be used without risk of conveying at excessive velocity. SCFM limiters restrict air flow to a preset SCFM. This maintains the desired SCFM air flow at the inlet, which is critical for proper conveying for a given size conveying line. This concept is the subject of pending U.S. patent application Ser. No. 14/185,016.

Reading vacuum levels at various points tells the controlling processor if the line is open, which means only air and no material is present and air is flowing unrestrictedly. This signals a loss of material at the source. A high vacuum reading indicates a plugged or nearly plugged line. Normal conditions are present where material is flowing correctly at detected mid-vacuum levels.

One line size for all receivers assures the resin transport velocity is more likely to be in the acceptable range. However, most processes require the basic resin material be delivered at 50 times the rate of additives, such as color concentrate. Virgin (or natural) pellets may have to be loaded at a rate of 1000 pounds per hour, requiring a 2.5 or 3 inch line size, while color is only required to be delivered at a rate of 20 to 40 pounds an hour. A smaller receiver is used for color, namely a receiver one that loads perhaps 5 pounds at a time, while the receiver for the virgin resin material will be larger, perhaps loading 50 pounds of each load cycle. A 2.5 inch line on a 5 pound receiver would be too large. 1.5 inch line would be standard, and the use of 1.5 inch resin conveying line would be better. But this risks velocities that are excessive. This results in trade-offs in design.

By placing a flow limiter at the pump suction intake, one can limit the maximum SCFM air flow to the design limit of the air flow limiter device; this is disclosed and claimed in pending U.S. patent application Ser. No. 14/185,016, noted above.

Receivers of the general type to which this invention relates are disclosed in U.S. Pat. No. 8,070,844 issued 6 Dec. 2011 in the name of Stephen B. Maguire and in U.S. Pat. No. 8,753,432 issued 10 Jun. 2014 in the name of Stephen B. Maguire.

### SUMMARY OF THE INVENTION

In one of its aspects, this invention embraces apparatus for pneumatically supplying granular plastic resin material from the supply to at least one receiver for temporary storage of the resin material prior to transfer to a process machine. In this aspect, the apparatus includes a vacuum pump having a suction intake and a first conduit connecting the resin supply to the receiver. A second conduit connects the receiver to the vacuum pump suction intake. The invention further embraces a sensor for measuring time required for loading the receiver with resin material whenever an associated process machine needs additional material. The apparatus in this aspect of the invention further includes a microprocessor for comparing times measured by the sensor and triggering an alarm when consecutively compared times increase by a pre-selected amount.

In another one of its aspects, this invention provides apparatus for determining when a filter of a granular resin material receiver, providing granular resin material to an associated process machine, is at reduced filtering efficiency. In this aspect of the invention, the apparatus includes a sensor for measuring time required for loading the receiver with resin material whenever the associated process machine needs additional material; the receiver is loaded in response to that need. The apparatus in this aspect of the invention further includes a microprocessor for comparing times measured by the sensor and triggering an alarm when consecutively compared times increase by a pre-selected amount.

In yet another one of its aspects, this invention provides a method for determining when a filter of a granular resin material receiver, which is providing granular resin material to an associated process machine, is at reduced filtering efficiency. The method proceeds with measuring time required for loading the receiver with resin material as the receiver is loaded in response to the associated process machine requiring resin material. The method further proceeds by comparing the measured times and triggering an alarm upon a measured time increasing over a previously measured or predetermined time by a pre-determined amount. Preferably, the measured times are consecutive times.

### DESCRIPTION OF THE DRAWINGS

FIG. 1 is a schematic representation of a resin delivery system manifesting aspects of the invention.

### DETAILED DESCRIPTION OF THE INVENTION

In this application, unless otherwise apparent from the context it is to be understood that the use of the term “vacuum” means “air at slightly below atmospheric pressure.” The “vacuum” (meaning air at slightly below atmospheric pressure) provides a suction effect that is used to draw granular plastic resin material out of a supply and to convey that granular plastic resin material through various conduits to receivers where the granular resin material can be temporarily stored before being molded or extruded. Hence, it is useful for the reader mentally to equate the term “vacuum” with the term “suction”.

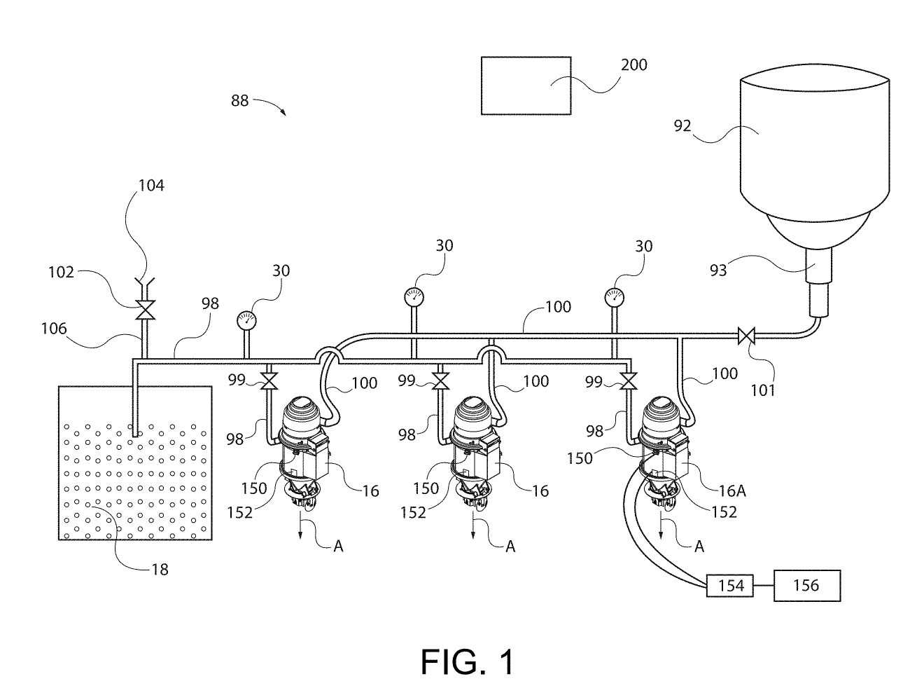

Referring to FIG. 1, apparatus for conveying granular plastic resin material from the supply to receivers that retain and then dispense the resin material when needed by a process machine is illustrated. The apparatus, which is designated generally 88 in FIG. 1, preferably includes a vacuum pump designated generally 92 and shown schematically in FIG. 1.

Still referring to FIG. 1, vacuum drawing conduit 100 is connected to a plurality of receivers 16, each of which receives, retains and dispenses, as needed, granular plastic resin material to a process machine, such as a gravimetric blender, or an extruder, or a molding press, as located preferably below a receiver 16. The process machines are not illustrated to enhance the clarity of the drawings.

Further illustrated in FIG. 1 is a hopper 18 for storage of granular plastic resin material therein and a resin conveying conduit 98, which serves to draw resin from hopper 18 and to deliver the resin through resin conveying conduit 98 to the respective receivers 16. This occurs in response to vacuum being drawn by the vacuum pump, with vacuum propagating through vacuum drawing conduit 100, the various receivers 16, and resin conveying conduit 98, to hopper 18. During operation of the resin conveying system shown schematically in FIG. 1, upon actuation of vacuum pump 92, vacuum is drawn at vacuum pump suction head 93. This vacuum, as it propagates to hopper 18, draws resin out of hopper 18 and into respective receivers 16.

Receivers are equipped with filters. The resin material delivered to a processing plant contains dust. As the resin pellets are pulled out of resin storage hopper 18, the resin pellets necessarily contact one another, thereby causing small chips of resin material to drop off the main resin pellets, creating additional dust. Moreover, as the resin is conveyed, tiny particles of resin drop off the larger resin pellets as the resin pellets glance against the wall of the conveying conduit, creating still more dust.

The dust cannot be permitted to enter a process machine, namely a molding press or an extruder, with the resin pellets. In the case of a clear plastic molded product, the dust would cause cloudiness in the product when clarity of the finished molded product is required. In all cases, for both clear and colored products, dust would interfere with the manufacturing process.

Dust is typically removed from the resin as the resin is conveyed from the resin supply to the process machine, by a filter positioned in the receiver. Each receiver conventionally has a filter. As resin material passes through the receiver, the filter gradually accumulates dust from the resin passing through the receiver. As dust accumulates in the filter, filter efficiency drops and, if the filter is not cleaned or changed, the filter eventually clogs with dust and no longer functions. If the filter no longer functions, dust may travel with the resin pellets and may enter the process machine, resulting in manufacture of defective, unacceptable parts. Alternatively, the dust may accumulate in the filter in such a way as to completely block the filter and thereby block or stop resin material from passing through the receiver and on to the process machine. In either case, it is important for the plant operator to know that the filters in the receivers are functioning properly and are not on the verge of being clogged with dust and hence ceasing to function.

As a receiver filter fills with dust, air flow through the receiver is necessarily impeded, thereby resulting in a slowdown of the resin filling process at the receiver. So, a slower receiver fill time indicates that the receiver filter is becoming filled with dust.

This invention addresses the problem of clogged receiver filters and maintaining receiver filters in a sufficiently open condition that conveyance of the granular resin material from the resin supply to the process machine may continue without substantial interruption. The invention monitors fill time for each receiver and compares fill time for that receiver to a known acceptable fill time for that receiver or a comparable receiver having an open, unclogged filter. As the fill time for the receiver drops to below a level corresponding to an acceptable fill time for that receiver or a comparable receiver having an acceptably open, unobstructed filter, the invention sounds an alarm, which may be audible or electronic, indicating that the filter in the receiver must be changed. Upon receiving the alarm, an operator may either manually change the filter or, in the case of self-cleaning receivers, the operator or a microprocessor may actuate a switch to energize the receiver filter cleaning function. Desirably, the fill times for each receiver as monitored are transmitted wirelessly to a central controller, where those fill times are compared to a known acceptable fill time for a receiver with an acceptably open filter. Alternatively, wires can be used to transmit the sensed fill time from a given receiver to a central microprocessor or other control device. If the fill time is excessively long, an operator or a microprocessor may shut down the receiver or even the entire system.

Referring to the drawings again, a receiver 16A is equipped with a high resin level sensor 150 for sensing when resin level within receiver 16A reaches a predetermined acceptable high level. Receiver 16A further includes a low resin level sensor 152 for determining when resin within receiver 16A reaches an unacceptably low level such that receiver 16A must be replenished with resin. As further illustrated schematically in FIG. 1, a timer 154 is connected to high level sensor 150 and to low level sensor 152 by unnumbered wires. A microprocessor 156 is connected by an unnumbered wire to timer 154. While wire connections have been illustrated in FIG. 1, wireless connectivity is preferable as between and among high and low level sensors 150, 152, and timer 154, and microprocessor 156.

High level sensor 150 may be optical in nature, or may be mechanical in nature, or may be electrical in nature. An optical sensor 150 employs a light beam or infrared beam passing across all or a portion of receiver 16A to detect when resin level in receiver 16A has reached an acceptably high level and receiver 16A is acceptably full of resin. Similarly, an optical sensor if used as low resin level sensor 152 employs a light beam or an infrared beam passing through a lower portion of receiver 16A to detect when resin within receiver 16A has reached an unacceptably low level and replenishment of receiver 16A is required.

Timer 154 receives signals from high level sensor 150 and low level sensor 152, regardless of the means by which those sensors detect resin level, and measures and records the time required for the resin level to rise from the predetermined low level to the predetermined high level. A microprocessor 156 processes the time interval, compares it to previous time intervals, and provides an alarm signal in the event the currently measured time level is inconsistent with previously measured time intervals required for fill of receiver 16A.

It is further within the scope of the invention to have timer 154 actuated by a signal coming from a central control system that regulates fill and refill of all receivers 16. This type of connection has not been illustrated in FIG. 1. Similarly, a signal coming from a central control station triggering shutoff of resin flow into a receiver 16 may be used as the trigger for the high resin level indication provided to timer 154.

Sensors 150, 152 may also be mechanical in nature, having reed switches or other switches that are physically moved by the resin in the receiver 16A and are spring loaded to return to a null position when those switches are not actuated. Sensors 150, 152 may also be electrical sensors which sense the electrical conductivity of any resin in the vicinity of the sensor and thereby provide a signal as to whether there is resin at the predetermined high or low level, according to the sensor of interest.

This invention may be embodied in other specific forms without departing from the spirit or essential characteristics of the invention. The disclosed embodiments are therefore to be considered in all respects as being illustrative and not restrictive with the scope of the invention being indicated by the appended claims rather than by the foregoing description. All changes which come within the meaning and range of equivalency of the claims are therefore intended to be embraced therein.

As discussed above and from the foregoing description of the exemplary embodiments of the invention, it will be readily apparent to those skilled in the art to which the invention pertains that the principles and particularly the composition and methods disclosed herein can be used for applications other than those specifically mentioned. All such applications of the invention are intended to be covered by the appended claims unless expressly excluded therefrom.

As used in the claims below, “comprising” means “including” while “consisting of” means “having only”, and “consisting essentially of” means having the stated constituents plus trivial amounts of other reagents which do not materially affect the claimed invention or products embodying the same.

The scope of the invention is, therefore, indicated by the appended claims rather than by the foregoing description and all changes which come within the range of equivalency of the claims are to be considered to be embraced within the scope of the claims. Additional objects, other advantages, and further novel features of the invention will become apparent from study of the appended claims as well as from study of the foregoing detailed discussion and description of the preferred embodiments of the invention, as that study proceeds.

The following is claimed:

1. Apparatus for pneumatically supplying granular material from a supply to at least one receiver for temporary storage of the granular material prior to transfer to a process machine, comprising:
a. a vacuum pump having a suction intake;
b. a first conduit connecting the granular material supply to the receiver;
c. a second conduit connecting the receiver to the vacuum pump suction intake;
d. a timer for measuring time required for loading the receiver with granular material whenever process machine needs additional material and the receiver is loaded;
e. a microprocessor for comparing times measured by the timer and triggering an alarm when consecutively compared times increase by a preselected amount.

2. Apparatus for determining when a filter, of a granular material receiver providing granular material to an associated process machine, is at reduced filtering efficiency comprising:
a. a timer for measuring time required for loading the receiver with granular material whenever the associated process machine needs additional material and the receiver is loaded in response to that need;
b. a microprocessor for comparing times measured by the timer and triggering an alarm when consecutively compared times increase by a preselected amount.

3. A method for determining when a filter, of a granular material receiver providing granular material to an associated process machine, is at reduced filtering efficiency, comprising:
a. measuring time required for loading the receiver with granular material when the receiver is loaded in response to the associated process machine requiring granular material; and
b. comparing the measured times and triggering an alarm upon a measured time increasing over a previously measured time by a predetermined amount.

4. The method of claim 3 wherein the measured times are consecutive times.

5. The method of claim 3 wherein measuring time further comprises:
a. sensing when granular material in a receiver drops to a predetermined level;
b. issuing a granular material refill signal upon granular material in a receiver dropping to the predetermined low level;
c. initiating a timer in response to the granular material refill signal;
d. sensing when granular material level in the receiver reaches a predetermined high level and providing a signal indicative thereof;
e. stopping the timer in response to the sensor signaling that the granular material has reached the predetermined high level.

6. The method of claim 5 wherein sensing when granular material in a receiver drops to a predetermined level is performed optically.

7. The method of claim 5 wherein sensing when granular material level in a receiver drops to a predetermined level is performed mechanically.

8. The method of claim 5 wherein sensing when granular material in a receiver drops to a predetermined level is performed electrically.

9. The method of claim 5 wherein sensing when granular material in a receiver reaches a predetermined high level is performed optically.

10. The method of claim 5 wherein sensing when granular material in a receiver reaches a predetermined high level is performed mechanically

11. The method of claim 5 wherein sensing when granular material in a receiver reaches a predetermined high level is performed electrically.

12. Apparatus of claim 1 further comprising a sensor for signaling when granular material in the receiver has reached a predetermined high level.

13. Apparatus of claim 1 further comprising a sensor for signaling when granular material in the receiver has reached a predetermined low level.

14. Apparatus of claim 12 wherein the sensor is optically actuated.

15. Apparatus of claim 12 wherein the sensor is mechanically actuated.

16. Apparatus of claim 12 wherein the sensor is electrically actuated.

17. Apparatus of claim 13 wherein the sensor is optically actuated.

18. Apparatus of claim 13 wherein the sensor is mechanically actuated.

19. Apparatus of claim 13 wherein the sensor is electrically actuated.
